(19) United States
(12) Patent Application Publication
(10) Pub. No.: US 2019/0052528 A1
(43) Pub. Date: Feb. 14, 2019

(54) NETWORK FUNCTION VIRTUALIZATION MANAGEMENT ORCHESTRATION APPARATUS, METHOD

(71) Applicant: NEC Corporation, Minato-ku, Tokyo (JP)

(72) Inventors: Yuki YOSHIMURA, Tokyo (JP); Tadaaki MIYATA, Tokyo (JP); Hajime ZEMBUTSU, Tokyo (JP); Yutaka NISHIGORI, Tokyo (JP)

(73) Assignee: NEC Corporation, Minato-ku, Tokyo (JP)

(21) Appl. No.: 16/080,350

(22) PCT Filed: Mar. 28, 2017
(86) PCT No.: PCT/JP2017/012512

§ 371 Date: Aug. 28, 2018

(30) Foreign Application Priority Data
Mar. 28, 2016 (JP) 2016-063169

(51) Int. Cl. H04L 12/24; H04L 12/26; G06F 9/455

(52) U.S. Cl. CPC H04L 41/0813; H04L 41/20; G06F 2009/45591; G06F 9/45558; G06F 2009/45595; H04L 43/16

(57) ABSTRACT

There is provided an apparatus comprising: a unit that receives, from a sender, a registration request of an execution condition of a lifecycle of a virtual function under a virtual environment and registers the execution condition of the lifecycle in a storage unit; a unit that secures in advance one or more resources necessary for execution of the lifecycle in the virtual function; a unit that determines whether or not the execution condition of the lifecycle registered in the storage unit is satisfied; a unit that instructs the execution of the lifecycle when the execution condition of the lifecycle is satisfied; and a unit that notifies the lifecycle execution result to the sender of the registration request of the execution condition of the lifecycle.

### FIELD

### DESCRIPTION OF RELATED APPLICATION

The present invention is based on the priority claim of the Japanese Parent Application: Japanese Patent Application No. 2016-063169 (filed on Mar. 28, 2016), the entire contents of which are incorporated by reference in this application with citation.

The present invention relates to a network functions virtualization management and orchestration apparatus, method and program.

### BACKGROUND

It is known that NFV (Network Functions Virtualization) implements on ore more network functions of a network appliance(s) by software on a virtual machine (VM) which is caused to run on a virtualization layer such as a hypervisor (abbreviated as HV) provided on a server. FIG. 1 is a diagram which is cited from FIG. 5.1 (The NFV-MANO architectural framework with reference points) on page 23 of Non-Patent Literature 1.

VNF (Virtualized Network Function) 22 corresponds to an application that operates on a virtual machine (VM) provided on a server to implement a network function by software. A management function (management of configuration, fault, performance, security, etc. of VNF 22), termed as EM (Element Manager: element management) 23 is provided for each VNF 22 (EM may be an EMS (Element Manage System)). NFVI (Network Functions Virtualization Infrastructure) 21 is an infrastructure configured to virtualize, using a virtualization layer such as a hypervisor, hardware resources of a physical machine (server) such as computing, storage and network functions, as virtualized hardware resources such as virtualized computing, virtualized storage, and virtualized network to allow flexible handling of the resources.

NFV orchestrator (NFV Orchestrator: NFVO) 11 of NFV-MANO (NFV Management & Orchestration) 10 performs:
Orchestration of resources of NFVI 21;
Lifecycle management of network service (NS) instances (e.g., Instantiation, Scaling, Termination, Update, and the like of NS instances. The NFV orchestrator 11 manages NS catalog 14 and VNF catalog 15 and has a repository 16 of NFV instances and a repository 17 of NFVI resources.

VNF manager (VNFM) 12 performs lifecycle management (e.g., instantiation, update, query, scaling, termination, etc.) of VNF instance, event notification and the like.

Virtualized infrastructure manager (VIM) 13 performs, for example,
Resource management of computing, storage, network in NFVI 21,
Fault monitoring of NFVI 21,
Resource monitoring of NFVI 21, and so forth.

Of OSS/BSS 30, OSS (Operations Support Systems) is a generic term for systems (equipment, software, mechanisms, or the like) necessary for, for example, telecommunications carriers (carriers) to construct and operate services. BSS (Business Support Systems) is a generic term for information systems (equipment, software, mechanisms, or the like) used by a communication carrier (carrier) for charging of user fees, billing, customer support, or the like.

NS catalog (NS catalog) 14 represents a network service (NS) repository. The NS catalog (NS catalog) 14 performs support for generation and management of, for example,
Network service (NS) descriptor (NSD),
Virtual link descriptor (VLD),
VNF Forwarding Graph Descriptor (VNFFGD), and so forth.

VNF catalog (VNF catalog) 15 represents, for example, a repository of an on-boarded VNF package. The VNF catalog (VNF catalog) 15 includes for example,
VNFD (VNF Descriptor),
PNFD (PNF Descriptor), and so forth.

NFV instance repository 16 retains instance information of all VNFs and all network services (NSs). The VNF instance and the NS instance are described in VNF and NS records, respectively. These records are updated to reflect execution result of VNF lifecycle management operation and NS lifecycle management operation in a lifecycle(s) of each instance.

NFVI Resources Repository 17 retains information on NFVI 21 resources available/reserved/allocated extracted by VIM 13 to provide information useful for reservation, assignment, monitoring, and so forth. Since the NFVI resource repository 17 is traceable for NS and VNF instances associated with reserved/allocated resources of the NFVI 21, it is important for resource orchestration of NFVO 11, where the reserved/allocated resources of the NFVI 21 may be such resources as the number of virtual machines (VM) used by the VNF 22 at any time during a lifecycle of the VNF 22).

In FIG. 1, a reference point Os-Ma-nfvo is a reference point between OSS/BSS 30 and NFVO 11, and is used for transfer of:
Network service lifecycle management request,
VNF Lifecycle management request,
Forwarding of NFV related state information, Exchange of policy management information, and so forth.

A reference point Vi-Vnfm is used for
Resource allocation request from VNFM 12 to VIM 13,
Exchange of virtualized resource configuration and state information and so forth.

A reference point Ve-Vnfm-em is used between EMS 23 and VNFM 12 for
VNF instantiation, VNF instance retrieval, VNF instance update, VNF instance termination, VNF instance scaling-out/in, VNF instance scaling-up/down,
Forwarding of configuration and events from EM (EMS) 23 to VNFM 12, and Notification of configuration and events regarding VNF from VNFM 12 to VNF 22, and so on.

A reference point Ve-Vnfm-Vnf is used between VNF 22 and VNFM 12, for
VNF instantiation, VNF instance retrieval, VNF instance update, VNF instance termination, VNF instance scaling-out/in, VNF instance scaling-up/down,
Forwarding of configuration and events from VNF to the VNFM, and Notification of configuration and events regarding VNF from VNFM 12 to VNF 22, and so on.

A reference point Nf-Vi is used for VM allocation with indication of compute/storage resource, update of VM resources allocation, VM migration, VM termination, creation and removal of connection between VMs, virtual resources allocation in response to a resource allocation request, forwarding of virtual resource state information, exchange of configuration and state information of hardware resources, and so on.

A reference point Vn-Nf indicates an execution environment to be provided to VNF 22 by NFVI 21.

A reference point Or-Vnfm is used for
Resource related request (authentication, reservation, allocation, etc.) by VNFM 12,
Forwarding of configuration information to VNFM 12, and collection of VNF state information.

A reference point Or-Vi is used for,
Resource reservation request from NFVO 11 to VIM 13, allocation resource request, and exchange of configuration and state information of virtualized resources (for details, see Non-Patent Document 1).

It is noted that NSD (Network Service Descriptor) of the NS catalog 14 is a network service deployment template (Network Service Deployment Template). NSD includes an entity that defines a script/workflow of network function of a specific lifecycle (Instantiation, termination, scaling, etc.).

VNFFGD (VNF Forwarding Graph Descriptor) is a deployment template that describes a network service topology or a part of the topology by referring to the VNFs, PNFs, and Virtual Links connecting those VNFs and PNFs.

VLD (Virtual Link Descriptor) is a deployment template that describes resource requirements necessary for links between the VNFs, between the PNFs, and between NS endpoints (endpoints) that can be used by the NFVI.

VNFD (VNF Descriptor) of the VNF catalog 15 is a deployment template describing VNF from a viewpoint of deployment and operational behavior requirement. VNFD is mainly used by VNFM 12 in VNF instantiation (generation) and VNF instance lifecycle management. VNFD is used by NFVO 11 for network service, management of virtual resources on NFVI 21 and orchestration (automation of computer system/middleware/service deployment/configuration/management). Contains connectivity interface KPI (Key Performance Indicators) requirement used by NFVO 11 for constructing a virtual link between VNFC instances or between a VNF instance of NFVI 21 and an end point to the other network function.

PNFD (Physical Network Function Descriptor) of the VNF catalog 15 describes connectivity, interface and KPI requirements of a virtual link, for an attached physical network function. PNFD is needed when a physical device is incorporated into an NS. PNFD facilitates addition of a network.

An instantiation operation of NS or VNF is executed from OSS/BSS 30 or VNFM 12 to NFVO 11. As a result of the instantiation operation, a record representing a newly created instance is created. For example, each record created based on information given in each descriptor and additional runtime information associated with a component instance provides data for modeling an instance state of a network service (NS).

As types of the instance records (NFV Instances) to be created, there may be listed the following types, for example:
Network Service Record (NSR);
VNFFG Record (VNFFGR);
Virtual Link Record (VLR);
VNF Record (VNFR); and
PNF Record (PNFR).

Information elements of the NSR, the VNFR, the VNFFGR, and the VVLR provide a data item group necessary for modeling states of an NS instance, a VNF instance, a VNFFG instance, and a VL instance. The PNF Record indicates an instance related to a pre-existing PNF which is part of an NS and includes a set of runtime attributes regarding PNF information (including connectivity relevant to the NFVO).

For scale-out of a system (expansion of server) with non-virtualization technology, servers (physical machines) are prepared in advance in each system unit, and addition of a server(s) or the like, for example, is performed manually.

Scaling is facilitated by implementing the NFV architecture described with reference to FIG. 1. VNF instance scaling may be performed, for example, when it is decided that
Quality of service becomes unsatisfactory and expansion of capacity is required, and
Capacity contraction is possible without affecting quality.

In a case where decision of VNF instance scaling is performed by a VNF that is equipped with a monitoring function or a threshold crossing detection function, the VNF may notify EM (EMS) of the capacity expansion (contraction), and the EM (EMS) may notify VNFM, or VNF may notify VNFM directly of the capacity expansion (contraction). Alternatively, the VNFM 12 may determine scaling. The scaling action of the VNF instance may be provided by a VNF descriptor (VNFD).

Scaling may be determined by VIM 13 or OSS/BSS 30, and may be manually performed by a maintenance personnel from a maintenance terminal or the like (not shown).

A scaling action may include:
VM (scale-up, addition of CPU (Central Processing Unit) and/or memory addition),
Addition of new VDU (Virtual Deployment Unit) instance (scale out),
Shutting down and deleting instances (scale in),
releasing (scaling down) the resources of the existing instance,
Increase of available network capacity,
Increase in bandwidth, and so forth.

It is noted that in FIG. 1, the VNF 22 on the NFVI 21 shares physical resources among the systems. For this reason, there is a possibility that necessary physical resources cannot be secured at the time when scaling out is required.

In the NFV-MANO 10, the scaling of the VNF instance is triggered by a load of the VNF 22 or the NFVI 21, for example.

FIG. 2 is a diagram illustrating a sequence of automatic VNF expansion (see B.4.4.1 Automatic VNF Expansion triggered by VNF performance measurement results, FIG. B.13 in Non-Patent Document 1). Automatic VNF expansion refers to addition of capacity of VNF. With addition of VNFC (VNF Component), or the like, supports addition of capacity to scale up virtual resources in VNF/VNFC, resulting in scaling out of VNF.

### <Step S1>

VNFM 12 collects performance measurement result from VNF 22 by a notification or acquisition operation of a performance measurement result of a VNF performance management interface.

### <Step S2>

From the performance measurement result, VNFM 12 detects that more resources are required.

### <Step S3>

The VNFM 12 requests the NFV orchestrator (NFVO) 11 for granting enlargement of VNF by specifying the VNF, using Grant Lifecycle Operation of VNF Lifecycle Operating Granting Interface based on specifications of CPU, memory, or the like set in the VNF descriptor (VNFD) (VNF, Scaling out)).

### <Step S4>

The NFVO 11 makes a scaling decision and checks the resource request. Checking the resource request may include checking whether or not the resource request can be covered by pooled resources, CPU type, memory, and so forth, and performing resource reservation to the VIM 13 as an option.

### <Step S5-S6>

The NFVO 11 reserves (reserves in advance) the requested resource by using the resource reservation operation (Create Resource Reservation operation) of the virtualized resource management interface.

### <Step S7>

The NFVO 11 grants a scale-out of the VNF 22 to the VNFM 12 and transmits an acknowledgment response ACK (ACKnowledgment).

### <Step S8>

The VNFM 12 instructs the VIM 13 to allocate resources (Allocate Resources). For example, the VNFM 12 transmits a virtual machine (VM) creation and activation request to the VIM 13. The VNFM 12 transmits a VIM identifier and VM parameter(s) instructed to the NFVO 12.

### <Step S9>

The VIM 13 creates and activates a network resource related to the VM and transmits an acknowledgment response ACK to the VNFM 12.

### <Step S10>

The VNFM 12 performs setting of the VNF 22 (setting parameters specific to deployment).

### <Step S11>

The VNFM 12 notifies the EMS 23 that the VNF has been updated by using a VNF lifecycle change notification interface (Notify VNF updated). The VNF lifecycle change notification interface notifies a state of the VNF instance due to a change in the VNF instance, such as change of the number of VDUs due to out-scaling or change of a VNF configuration.

### <Step S12>

The EM (EMS) 23 and the VNFM 12 update the updated VNF 22 as a managed device.

### <Step S13>

The EM (EMS) 23 configures the VNF with application-specific parameter(s).

### <Step S14>

The VNFM 12 notifies success of enlargement of the VNF 22 to the NFVO 11 by the VNF lifecycle change notification interface. The NFVO 11 recognizes that a new VNF configuration has been created.

### <Step S15>

The NFVO 11 maps the scaled-out VNF 22 to the VIM 13 and the resource pool.

FIG. 3 is a diagram illustrating a sequence of automatic VNF contraction (see B.4.4.3 Automatic VNF Contraction Triggered by VNF performance measurement results, Figure B.15 in Non-Patent Document 1). For automatic VNF contraction, VNFC termination by VNFM, resource release instruction from VNFM to VIM and so forth are performed.

### <Step S21>

The VNFM 12 collects a performance measurement result from the VNF 22 by an operation of notifying or acquisition of the performance measurement result of the VNF performance management interface.

### <Step S22>

The VNFM 12 detects necessity of reducing resources (release of capacity) from the performance measurement result.

### <Step S23>

The VNFM 12 requests the NFV orchestrator (NFVO) 11 to perform verification of contraction of VNF, using Grant Lifecycle Operation of VNF

Lifecycle Operating Granting Interface, based on a VNF template (CPU, memory, or the like) such as VNFD.

### <Step S24>

The NFVO 11 decides the scaling based on, for example, a set policy or the like.

### <Step S25>

The NFVO 11 grants a scale-in operation of the VNF to the VNFM 12. The NFVO 11 transmits an acknowledgment response ACK to the VNFM 12.

### <Step S26>

Graceful termination (automatic shutdown) of the VNF component (VNFC) is performed.

### <Step S27>

The VNFM 12 instructs the VIM 13 to release resource.

### <Step S28>

The VIM 13 releases the resource and transmits an acknowledgment response ACK to the VNFM 12.

### <Step S29>

The VNFM 12 notifies the NFVO 11 of a success of contraction of the VNF (Notify Successful contraction) using the VNF lifecycle change notification interface.

### <Step S30>

The VNFM 12 uses the VNF lifecycle change notification interface to notify the EM (EMS) 23 that the VNF releases the capacity and the VNF has been updated.

### <Step S31>

The NFVO 11 updates the VIM 13 and a resource pool map.

### <Step S32>

The EM (EMS) 23 and VNFM 12 update the VNF as a managed device.

When the EM (EMS) 23 starts expansion (contraction) (EM initiated VNF expansion (contraction)) of the VNF, the EM (EMS) 23 requests capacity expansion (contraction) to the VNFM using “Scale VNF of the VNF Lifecycle Management Interface.

Scale-out (scale-in) of NS (Network Service) instances are performed by issuing a request of scale-out (scale-in) of the NS (Network Service) instances to another deployment flavor registered in an NSD (Network Service Descriptor).

### [Non-Patent Literature 1]

ETSI GS NFV-MAN 001 V1.1.1 (2014-12) Network Functions Virtualisation (NFV); Management and Orchestration (Jan. 10, 2016 search) <http://www.etsi.org/deliver/etsi_gs/NFV-MAN/001_099/001/01.01.01 60/gs_NFV-MAN001v010101p.pdf>

### SUMMARY

The analysis by the present inventors will be given below.

As mentioned above, by implementing the NFV architecture, scaling of VNF instances such as automatic VNF expansion (contraction) .is facilitated.

However, in NFV-MANO, automatic scaling of VNF is triggered by loads or the like of VNF and NFVI.

For this reason, it is not possible to postulate an increase in necessary virtual resources in response to events such as local events (for example, firework festival, festivals, and so forth) and calendar (e.g.: holidays called O-bon, year-end and new-year holidays, and so forth) to secure resources in advance.

In addition, VNF is an application software that runs on a virtual machine on a server and shares physical resources (hardware resources) on the server among VNF systems. For this reason, there is a possibility that necessary resources (for example, physical resources) cannot be secured at a time when it becomes necessary to increase capacity or the like. For example, even if an attempt is made to secure resources using the resource reservation creation operation (Step S5 of FIG. 2), resources may not be reserved (the reservation result of Step S6 fails). In this case, scale-out or the like fails.

The present invention was invented in consideration of the above-described problems, and one of the objects thereof is to provide an apparatus, method, and non-transitory medium storing a program, each allowing lifecycle execution of a virtual function to be specified at an arbitrary timing and with an arbitrary condition and enabling to secure in advance virtual resource(s) according to lifecycle.

According to one aspect of the present invention, there is provided a network functions virtualization management and orchestration apparatus comprising:
a lifecycle execution condition registration unit that receives, from a sender, a registration request of an execution condition of a lifecycle of a virtual function under a virtual environment and registers the execution condition of the lifecycle in a storage unit;
a pre-resource securing unit that secures in advance one or more resources necessary for execution of the lifecycle in the virtual function;
a lifecycle execution condition determination unit that determines whether or not the execution condition of the lifecycle registered in the storage unit is satisfied;
a lifecycle execution instruction unit that instructs the execution of the lifecycle when the execution condition of the lifecycle is satisfied; and
a lifecycle execution result notification unit that notifies the lifecycle execution result to the sender of the registration request of the execution condition of the lifecycle.

According to another aspect of the present invention, there is provided a method for network functions virtualization management and orchestration comprising:
receiving, from a sender, a registration request of an execution condition of a lifecycle of a virtual function under a virtual environment to register the execution condition of the lifecycle in a storage unit;
securing in advance one or more resources necessary for execution of the lifecycle in the virtual function;
determining whether or not the execution condition of the lifecycle registered in the storage unit is satisfied;
instructing the execution of the lifecycle when the execution condition of the lifecycle is satisfied; and
notifying the lifecycle execution result to the sender of the registration request of the execution condition of the lifecycle.

According to another aspect of the present invention, there is provided a non-transitory computer readable medium storing a program causing a computer to execute processing comprising:
receiving, from a sender, a registration request of an execution condition of a lifecycle of a virtual function under a virtual environment to register the execution condition of the lifecycle in a storage unit;
securing in advance one or more resources necessary for execution of the lifecycle in the virtual function;
determining whether or not the execution condition of the lifecycle registered in the storage unit is satisfied;
instructing the execution of the lifecycle when the execution condition of the lifecycle is satisfied; and
notifying the lifecycle execution result to the sender of the registration request of the execution condition of the lifecycle. According to the present invention, the non-transitory computer readable recording medium storing the above program is such a recording medium as a HDD (Hard Disk Drive), a CD (Compact Disk), a DVD (Digital Versatile Disk), a semiconductor storage device or the like.

According to the present invention, the lifecycle execution of the virtual function can be specified at arbitrary timing and condition, and it is possible to secure in advance virtual resources according to the lifecycle.

### BRIEF DESCRIPTION OF THE DRAWINGS

FIG. 1 is a diagram based on Figure 5.1 of Non-Patent Literature 1.

FIG. 2 is a diagram based on Figure B.13 of Non-Patent Literature 1.

FIG. 3 is a diagram based on Figure B.15 of Non-Patent Literature 1.

FIG. 4 is a diagram illustrating an example of an example embodiment of the present invention.

FIG. 5 is a diagram for explaining an example embodiment of the present invention.

FIG. 6 is a diagram illustrating an operation sequence of an example embodiment of the present invention.

FIG. 7 is a diagram for explaining an example of lifecycle execution conditions registered in an example embodiment of the present invention.

FIG. 8 is a diagram illustrating another example of an example embodiment of the present invention.

FIG. 9 is a diagram illustrating resource reallocation in another example of the example embodiment of the present invention.

### DETAILED DESCRIPTION

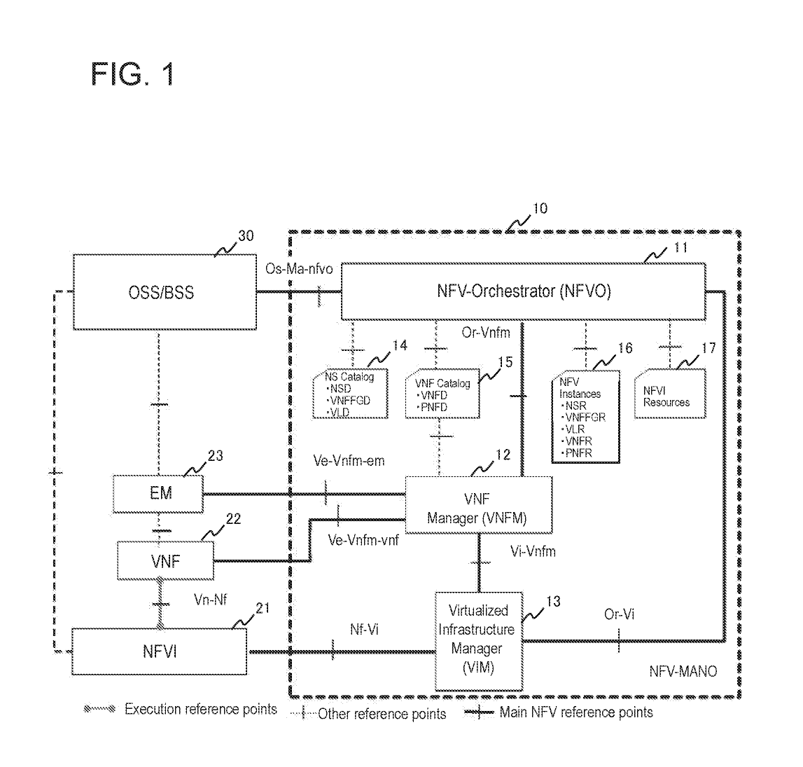

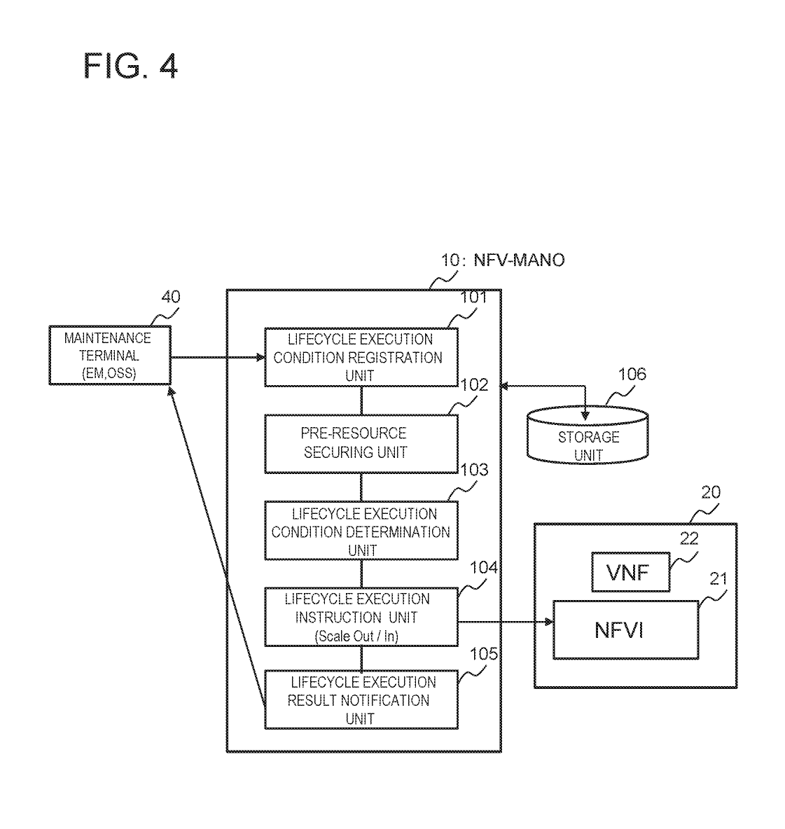

The following describes example embodiments of the present invention. FIG. 4 is a diagram illustrating an example embodiment of the present invention from a functional point of view. Referring to FIG. 4, a maintenance terminal (such as a maintenance device or the like or the EM, OSS in FIG. 1) 40 is provided with a network interface for communicating connection with an NFV-MANO 10 and transmits is a VNF lifecycle management request for requesting registration of an execution condition of a VNF lifecycle to the NFV-MANO 10. The NFV-MANO 10 has a network interface for communicating with the maintenance terminal (a maintenance device or the like, or EM, OSS in FIG. 1) 40.

The NFV-MANO 10 includes a lifecycle execution condition registration unit 101, a pre-resource securing unit 102, a lifecycle execution condition determination unit 103, a lifecycle execution instruction unit 104, and a lifecycle execution result notifying unit 105.

The lifecycle execution condition registration unit 101, on reception of a lifecycle execution condition registration request of a VNF which is a virtualized function under a virtual environment (for example, date/time information for executing a lifecycle, and the like), performs registration thereof in the storage unit 106.

The pre-resource securing unit 102 reserves resources necessary for executing lifecycle of VNF in advance.

The lifecycle execution condition determination unit 103 determines whether or not an execution condition (condition such as date and time, event, etc.) of the lifecycle registered in the storage unit 106 has been satisfied.

When it is determined that the execution condition of the lifecycle has been satisfied by the lifecycle execution condition determination unit 103, the lifecycle execution instruction unit 104 determines the lifecycle to be executed. When a virtual function is VNF, the lifecycle execution instruction unit 104 instructs, the NFVI 21 of the server 20, for example, to execute the lifecycle.

The lifecycle execution result notification unit 105 notifies the maintenance terminal (EMS, OSS, or the like) 40 of the lifecycle execution result.

The respective units in the NFV-MANO 10 may, as a matter of course, be configured not to be integrally incorporated in one apparatus but to be connected via one or more communication apparatuses for communication connection. Part or all of the units in the NFV-MANO 10 may be realized by a program executed by a computer (processor or the like). In this case, a computer (which may be a general-purpose computer such as a server) reads a program stored in a storage unit such as a semiconductor memory or HDD, for example, to a main memory to execute program instructions in corporation with a hardware such as a communication device (transmission device, reception device), to realize the corresponding function.

According to the present invention, an execution condition of the lifecycle of a VNF is registered, and resources necessary for executing VNF lifecycle are secured in advance, so that, for example, at a time point when the VNF needs scale-out, it is made possible to avoid occurrence of a situation in which necessary physical resources cannot be secured.

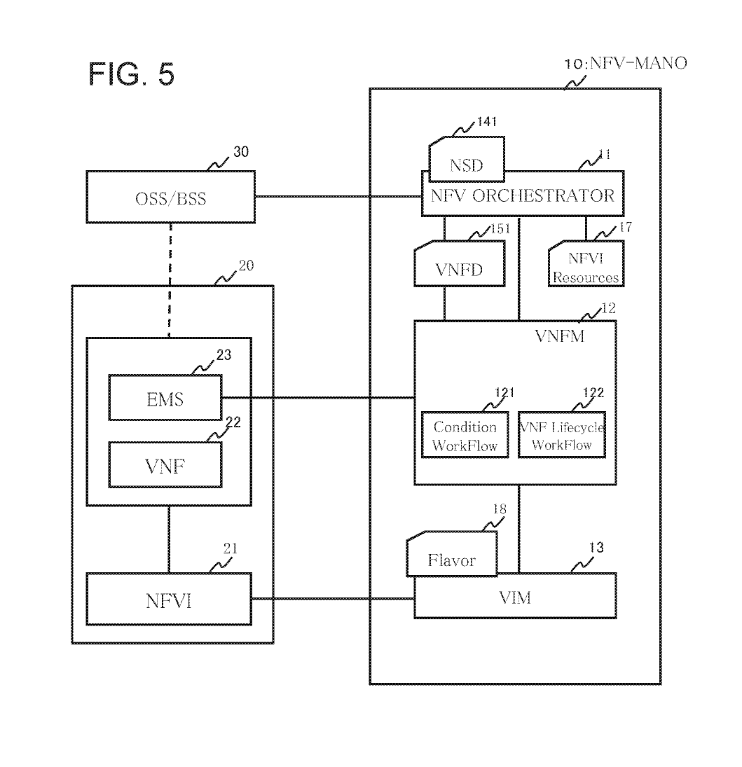

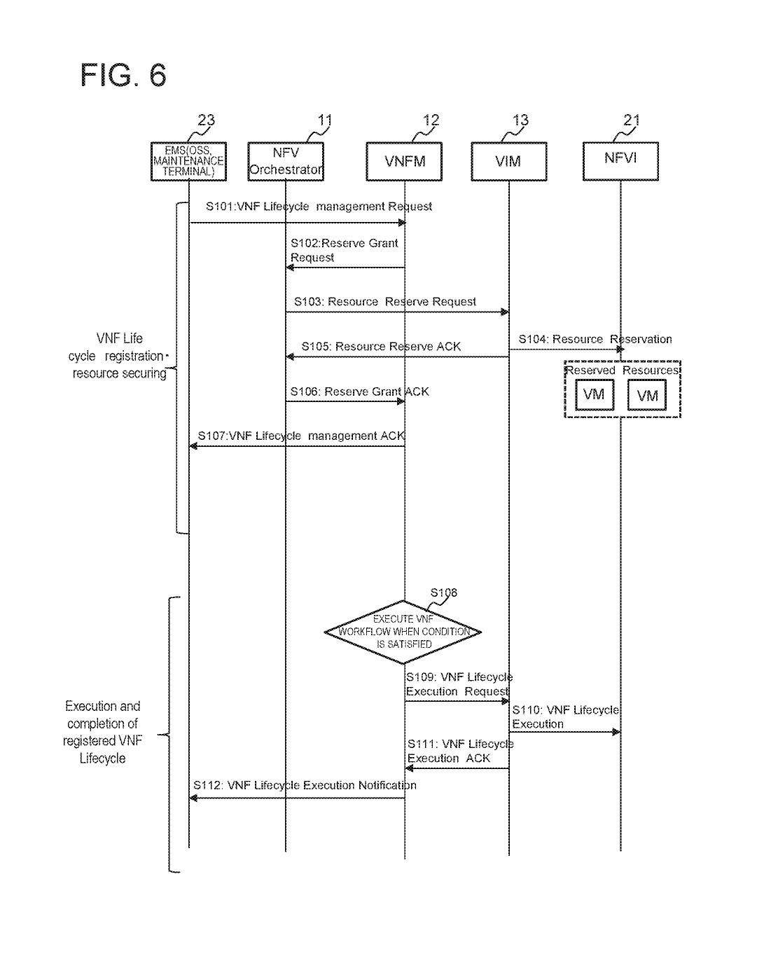

FIGS. 5 and 6 are diagrams for explaining an example in which the above-described example embodiment is embodied in the NFV architecture described with reference to FIG. 1. Although not limited thereto, in FIG. 6, an example (VM scale out) in which a lifecycle specified by an execution condition of the VNF lifecycle is addition of a virtual machine (VM) to be allocated to VNF (VDU). For example, two VMs are reserved in advance as resources (compute, storage, network resources, etc. of NFVI 21) secured in advance by reservation. The lifecycle specified by the execution condition of the VNF lifecycle may be scale up (addition of virtual CPU, increase of capacity of virtual memory, and so forth).

In FIG. 5, NFVI Resource Repository 17 holds resource information of the reserved NFVI 21.

### <Step S101: VNF Lifecycle Management Request>

A VNF lifecycle management request of the VNF lifecycle management interface is transmitted from the EMS 23 (maintenance terminal or the like) to the VNFM 12. The VNF lifecycle management request includes designation of an execution condition of the VNF lifecycle (for example, designation of the lifecycle execution date and time) and a registration request.

The VNFM 12, on reception of the registration request of the execution condition of the VNF lifecycle sets the condition in a condition workflow 121. The condition workflow 121 includes a workflow of a VNF lifecycle to be executed, an execution date and time, specification of execution repetition, execution priority information, and the like, among workflows registered in the VNF lifecycle workflow 122 that defines a work flow of the VNF lifecycle.

As an execution condition of the VNF lifecycle, for example, scale-out of a target VNF, a capacity of the scale-out, and an execution time (time point) may be registered.

A registration request of an execution condition of a VNF lifecycle may be transmitted from the OSS/BSS 30 to the NFV orchestrator (NFVO) 11 on the VNF lifecycle management interface. This interface enables request/management operation for associating NFVI resources with VNF (specifications such as VNFD in FIG. 1) from maintenance terminals (EMS, OSS or the like). In VNF lifecycle management, for example, scaling out/in of VNF, scale up/down of VNF, termination (stop), update, and the like are performed.

### <Step S102: Reserve Grant Request>

Based on the registered execution condition of the VNF lifecycle, the VNFM 12 finds resources necessary for VNF lifecycle execution (for example, scale out), and issues a resource reserve grant request needed to perform the VNF lifecycle (scale out, or the like).

### <Step S103: Resource Reserve Request>

On reception of the reserve grant request from the VNFM 12, the NFV orchestrator (NFVO) 11 transmits a resource reservation request to the VIM 13 via Or-Vi (see FIG. 1).

### <Step S104: Resource Reservation>

In accordance with the resource reserve request from the NFV orchestrator (NFVO) 11, the VIM 13 secures resources (virtualization resources, such as a virtual machine VM(s), a virtual CPU(s), a virtual memory(ies), or the like) in the NFVI 21. FIG. 6 illustrates a state in which the virtual machine VMs have been secured.

In the VIM 13, for example, a pre-resource reservation management number (identification information) is given to NFVI resources secured in advance and registered in the resource pool and managed. The pre-resource reservation management number is not limited to a number and it may include information such as ID information (identity information) of resources.

### <Step S105: Resource Reserve ACK>

The VIM 13 transmits a resource reservation acknowledgment response (Resource Reserve ACK) to the NFV orchestrator (NFVO) 11. The acknowledgment of this resource reservation may include a pre-resource reservation management number and the VIM 13 may notify the NFV orchestrator (NFVO) 11 of the pre-resource reservation management number.

### <Step S106: Reserve Grant ACK>

The NFV orchestrator (NFVO) 11 transmits a reserve grant acknowledgment response (Reserve Grant ACK) to the VNFM 12. An acknowledgment (Reserve Grant ACK) of the reservation approval may include the pre-resource reservation management number and notify the VNFM 12 of the pre-resource reservation management number.

<Step S107: VNF Lifecycle management ACK>

The VNFM 12 returns a VNF lifecycle management acknowledgment response (VNF Lifecycle Management ACK) to the EMS 23. The VNF lifecycle management acknowledgment includes an execution result of registration of the execution condition of the VNF lifecycle (the registration ID of the execution condition of the VNF lifecycle), the pre-resource reservation management number, and the like, and the VNFM 12 notifies them to the EMS 23.

Thus, registration of the VNF lifecycle and reservation (securing in advance, or pre-securing) of resources in the NFVI 21 are completed.

### <Step S108: Determination of Execution Condition of VNF Life Cycle>

When the reservation (securing in advance, or pre-securing) of the resource is completed, the VNFM 12 determines whether or not the execution condition of the registered VNF lifecycle is satisfied.

For example, the VNFM 12 checks whether or not a date and a current time of a clock (not shown) included in the VNFM 12 match the specified date and time (or event information such as a calendar) of the execution condition of the registered VNF lifecycle.

### <Step S109: VNF Lifecycle Execution Request>

When the execution condition of the VNF lifecycle is satisfied (for example, when the current date and time corresponds to the specified date and time of the registered VNF lifecycle execution condition), the VNFM 12 executes the VNF lifecycle workflow registered in the VNF lifecycle workflow 122. The VNFM 12 transmits a VNF lifecycle execution request to the VIM 13.

At that time, the VNFM 12 specifies the pre-resource reservation management number in the VNF lifecycle execution request and instructs the VIM 13 to execute the VNF lifecycle (for example, scale out) concerning the reserved resource corresponding to the pre-resource reservation management number. For example, in a case of scale-out of VNF, the VNFM 12 may instruct the VIM 13 to add a reserved virtual machine (VM) corresponding to the pre-resource reservation management number.

### <Step S110: VNF Lifecycle Execution>

The VIM 13 instructs the NFVI 21 to execute the VNF lifecycle execution.

Based on the instruction from the VIM 13, the NFVI 21 performs addition of reserved VM(s) to the existing VNF, for example.

### <Step S111: VNF Lifecycle Execution ACK>

The VIM 13 returns an acknowledgment response (VNF Lifecycle Execution ACK) of the VNF lifecycle execution to the VNFM 12.

### <Step S112: VNF Lifecycle Execution Notification>

The VNFM 12 transmits a VNF lifecycle execution notification to the EMS 23.

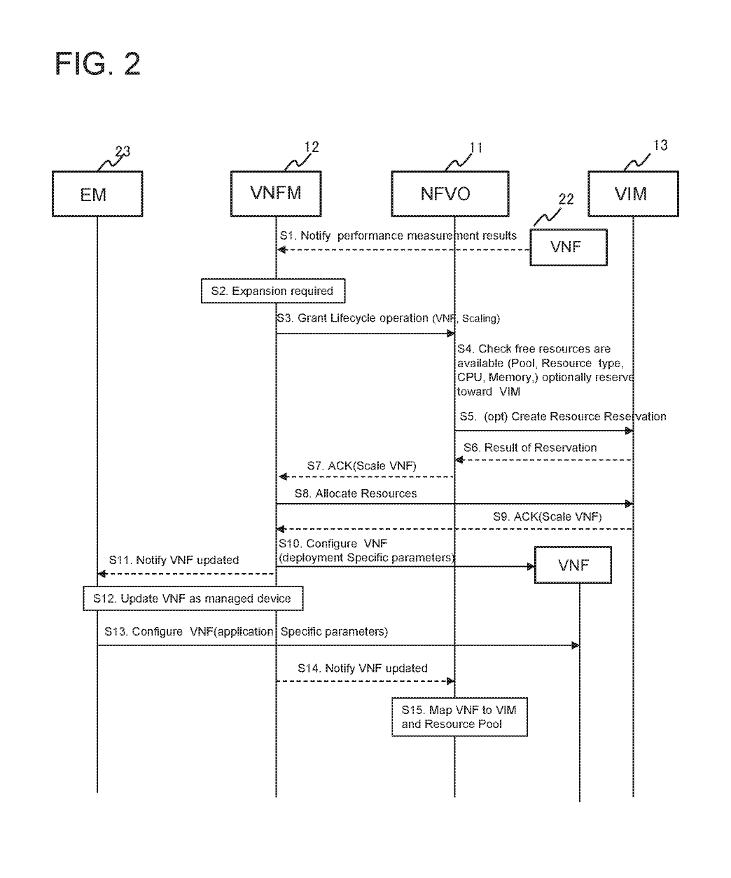

In step S109 in FIG. 6, if the VNF lifecycle execution request is a scale-out of VNF, the processing from step S8 in FIG. 2 (allocation of resources from VNFM 12 to VIM 13 (Allocate Resources)) may be executed at first. In this case, for example, according to the resource allocation instruction, the pre-resource reservation management number corresponding to the reserved virtual machine (VM) may be notified to the VIM 13.

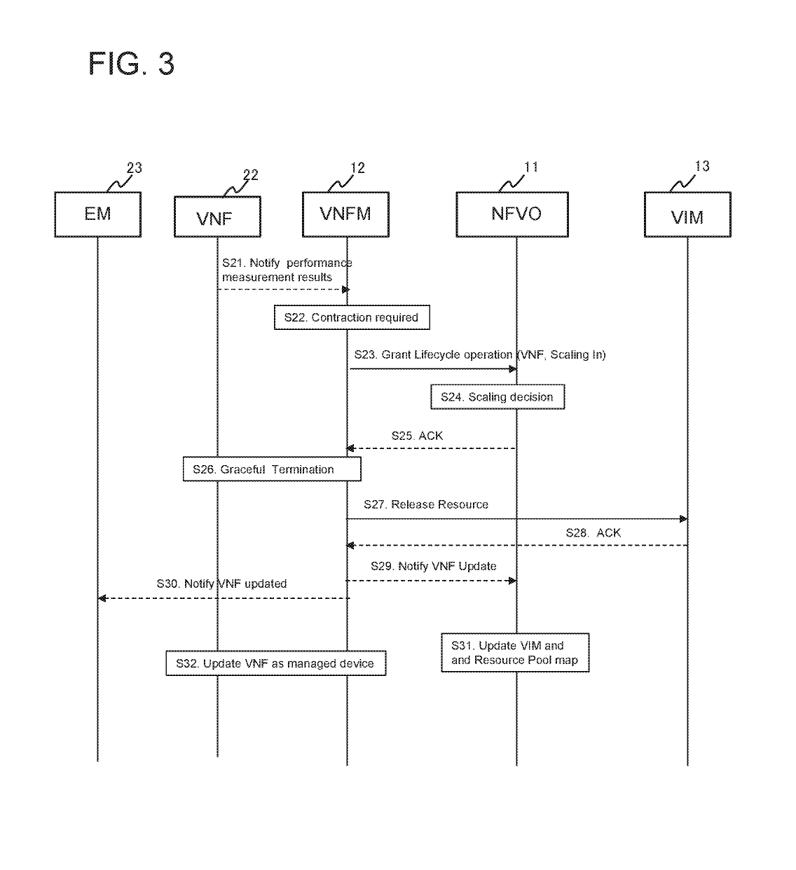

Alternatively, in step S109 of FIG. 6, when the VNF lifecycle execution request is a scale-in of the VNF, the resource capacity specified by the execution condition of the VNF lifecycle is released from the capacity allocated to the VNF. In this case, the VNFM 12 may shut down the VNF (Graceful Termination) via the NFVI and execute the processing from the step S27 in FIG. 3 as the step S109 in FIG. 6.

As described with reference to FIGS. 2 and 3, in NFV, the scaling is triggered by loads of VNF and NFV (performance measurement result), for example, it is impossible to perform scaling by arbitrary designation of an execution condition of the lifecycle and securing in advance of resources based on assumption of an increase in necessary virtual resources.

In order to solve this problem, according to the example embodiments, as described in the above, it is possible to perform setting of an arbitrary execution condition concerning a VNF lifecycle, and securing (in advance) of necessary resources before execution of VNF lifecycle to successfully perform scaling such as scale-out.

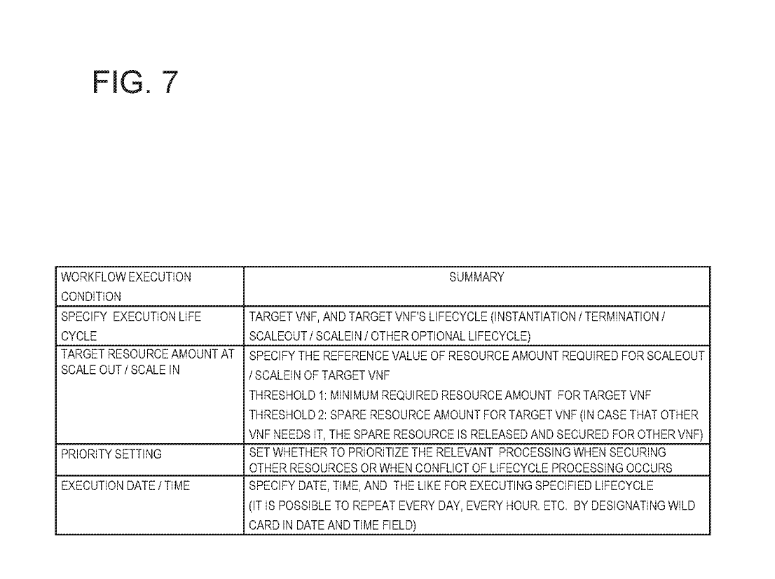

In the present embodiment, the specification of the execution condition of the VNF lifecycle for the VNFM 12 may include information exemplified in FIG. 7, for example, though not particularly limited thereto. Referring to FIG. 7, the “execution lifecycle specification” of the workflow execution condition of the execution condition of the VNF lifecycle may include
target VNF to be executed; and
lifecycle of the target VNF (instantiation (generation), termination (stop), scale-out, scale-in, any other VNF lifecycle).

“Target resource amount at scale-out/scale-in” of the workflow execution condition specifies a reference value of a resource capacity required for VNF at scale-out. It may also specify a reference value of the resource capacity to be released to the VNF at scale-in.

The “target resource amount at scale-out/scale-in” may include a threshold 1 and a threshold 2 to be assigned to resources allocated to VNF.

For example, the threshold 1 is the minimum necessary resource capacity. The threshold 2 is a capacity of a spare resource(s), and when the other VNF(s) require the spare resource, the spare resource(s) are released and reserved for the other VNFs. It is a matter of course that the thresholds assigned to the resources allocated to the VNF are not limited to the thresholds 1 and 2 but may include ranks of even more thresholds.

“Priority setting” of the workflow execution condition specifies whether to give priority to this processing (this workflow) when securing other resources to other VNF(s) or competing for the VNF lifecycle. When securing resources to other VNF(s) or competing in the VNF lifecycle, resources are secured to other high priority VNF(s), and priority is given to the lifecycle of the other high priority VNF(s).

“Execution date/time” of the workflow execution condition specifies execution date and time of VNF lifecycle. For example, by specifying a predetermined wild card as date and time, it is possible to execute the lifecycle every day, every hour. Alternatively, the “execution date/time” of the workflow execution condition may be a template configuration that enables to specify lifecycle execution every other day or the like.

The lifecycle of VNF is not limited to scale-out and scale-in, but it may include VNF instantiation, VNF instance termination, VNF instance query, and so forth, for example. Further, the execution condition of the VNF lifecycle is not limited to the information element that is shown in FIG. 7 and specified by the execution condition of the VNF lifecycle, but the execution condition of the VNF lifecycle desired by a registrant may be set as the execution condition of the VNF lifecycle.

According to the present example embodiment, it is possible to automate maintenance work of a VNF system and simplify maintenance process thereof, by registering a plurality of VNF lifecycles as execution conditions of the VNF lifecycle to cause a scenario(s) to be executed at a desired time specified or the like, can be simplified.

As is well known, use/request status of virtual resources in VNF is constantly changing according to processing load and the like.

Therefore, if resources are secured in advance for a certain VNF, there may occur such a case in which the securing in advance of resources of the certain VNF competes with a request of another VNF that originally requires a resource, or a case in which resources necessary for another VNF cannot be secured.

Therefore, in securing resources required by a VNF, preferably, as a condition to be specified by the lifecycle execution condition registration unit 101 in FIG. 4, a threshold and a priority are set for a predetermined range of resources secured in advance, as illustrated in FIG. 7.

As a result, for example, it is possible to reserve resources according to a usage status of virtual resource of a VNF and a request situation after execution of the VNF lifecycle.

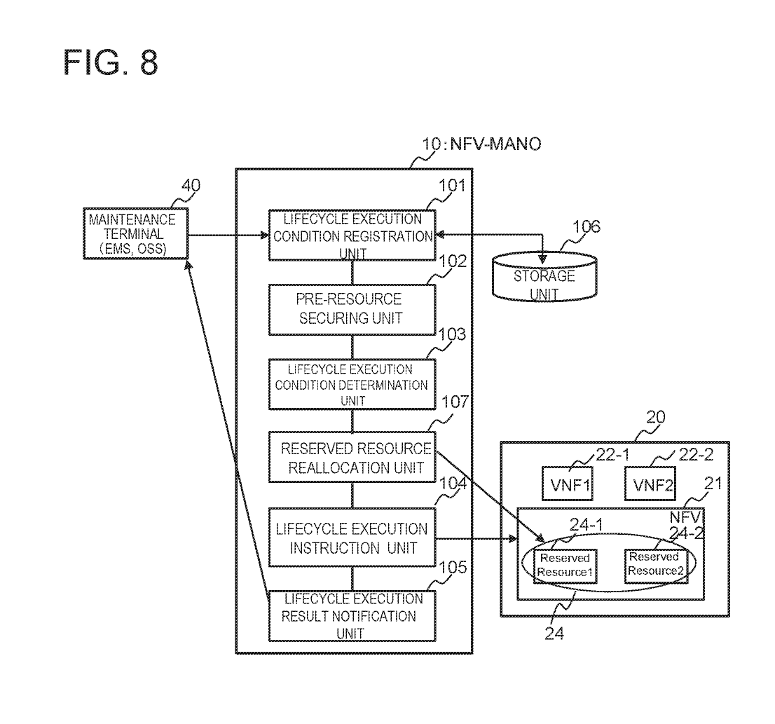

FIG. 8 is a diagram illustrating another example embodiment of the present invention. In FIG. 8, the same elements as those in FIG. 4 are denoted by the same reference numerals. The following describes differences from the configuration of FIG. 4. A reserved resource reallocation unit 107 releases a predetermined capacity that is set as a spare resource among resources 1 (24-1) secured in advance for the VNF 1, for example, performs reallocation of the released resources to resource 2 (24-2) reserved for VNF 2 (priority higher than VNF 1) which requires more resources. In addition, reference numeral 24 in FIG. 8 represents a pool (resource pool) of reserved resources in advance.

In the example of FIG. 8, resource 1 (24-1) secured in advance for VNF 1 is a resource secured in advance for VNF lifecycle execution. When a part of the resource 1 (24-1) is allocated to resource 2, resource configuration managed by the pre-resource reservation number is changed.

For example, in the case where a resource secured in advance for a VNF by reservation is a virtual machine (VM), specification and capacity value of the VM corresponding to the resource 1 registered in the flavor 18 managed by the VIM 13 in FIG. 5, are updated (for example, the number of vCPU (virtual CPU) is updated from 4 to 2, the capacity of virtual memory from 8 GB (Giga byte) to 4 GB, or the like). Further, a change in a virtual resource configuration of a VNF is notified from the VIM 13 in FIG. 5 to the NFVO 11, or from the VIM 13 to the VNFM 12.

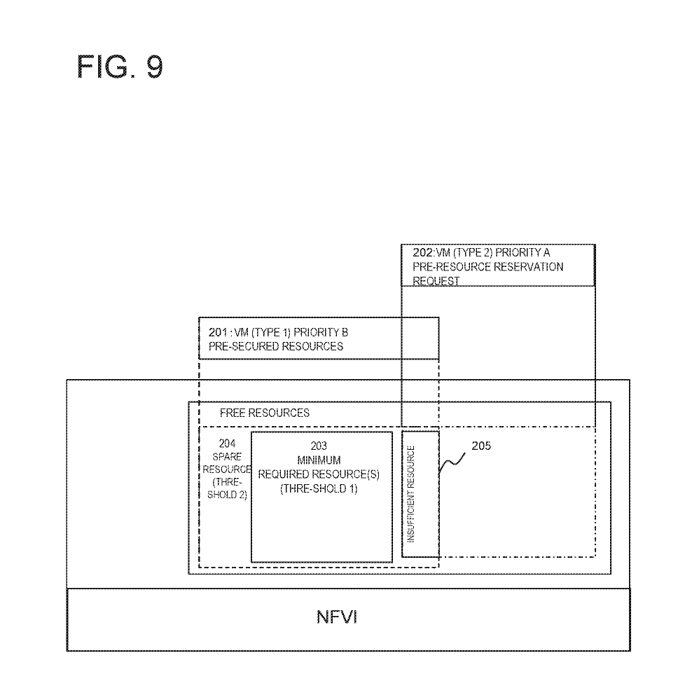

FIG. 9 is a diagram for explaining reallocation of resources of a virtual machine (VM) to a VNF by the reserved resource reallocation unit 107 in FIG. 8.

As an example of an execution condition of a VNF lifecycle, it is assumed that the following are specified as the execution condition of the VNF lifecycle,
VM (type 1) has priority B (low), and
VM (type 2) has priority A (high).

Here, a threshold 1 is the minimum necessary resource. A threshold 2 is a spare resource(s). (when the other VNF(s) require the spare resource, the spare resource(s) are released.)

As illustrated in FIG. 9, it is assumed that resources secured in advance are set to the VM (type 1) priority B (low). In this state, when resources already allocated for a resource request from a VM (type 2) priority A (high) are insufficient, among resources 201 secured in advance for the VM (type 1) priority B, the minimum required resource (s) 203 (threshold 1) is (are) left for the VM (type 1) priority B (low), a necessary amount of resource 205 from the spare resource 204 with the threshold 2 is released, and is allocated to the VM (type 2). As a result, it is possible to provide resources from the resources secured in advance for the VM having a relatively low priority to the other VNF (operating on a high priority VM) which requires additional resources due to insufficiency of secured resources.

The present example embodiment can be suitably applied to securing in advance of required resources of a system requiring 24 hours non-stop operation without affecting end users, such as a virtualized communication server (VNF), as in a case of non-virtualization and a system which requires simplification of a maintenance work and execution of the scenario in various kind of virtualization servers (VNFs).

In the above embodiment, the lifecycle management such as scale-out and scale-in of the VNF has been described. However, regarding a lifecycle such as scale-out and scale-in of NS (Network Service) instances, as with the advance registration of an execution condition of the VNF, execution condition(s) of the NS instance lifecycle are registered in advance, VNFs or the like necessary for the execution of the NS instance lifecycle are secured in advance and at a time when the execution condition of the NS instance lifecycle is established, NFVO may perform scale-out, or scale-in of the NS instance. For example, assuming that VNFA and VNFB are different VNFs with different functions, when the execution condition of the registered NS instance lifecycle is satisfied, a switching from a network service (NS) instantiated (generated) with a flavor A (one VNFA+two VNFBs) to a network service (NS) instantiated (generated) with another flavor B (two VNFAs plus two VNFBs) may be performed (scale out). That is, an instance of a virtual function that is targeted for lifecycle management under a virtual environment is not limited to a VNF instance and may be an NS instance or the like.

Further, a lifecycle of a virtual function is not limited to the above. It may include generation (instantiation), various kinds of control, startup, stop, restart, monitoring, operation conditions, and the like of an instance of a virtual function.

The disclosure of the above-described non-patent literature shall be incorporated by reference in this document. Within the framework of the entire disclosure (including the scope of claims) of the present invention, it is possible to change/adjust the embodiment or example based on the basic technical ideas. Also, various combinations or selections of various disclosed elements (including each element of each claim, each element of each embodiment, each element of each drawing, etc.) are possible within the scope of the claims of the present invention. That is, it goes without saying that the present invention includes various variations and modifications that could be made by those skilled in the art according to the entire disclosure including the claims, and technical ideas.

The above-described embodiment is added, for example, as follows, though not limited thereto.

### (Supplementary Note 1)

A network functions virtualization management and orchestration apparatus comprising:
a lifecycle execution condition registration unit that receives, from a sender, a registration request of an execution condition of a lifecycle of a virtual function under a virtual environment and registers the execution condition of the lifecycle in a storage unit;
a pre-resource securing unit that secures in advance one or more resources necessary for execution of the lifecycle in the virtual function;
a lifecycle execution condition determination unit that determines whether or not the execution condition of the lifecycle registered in the storage unit is satisfied;
a lifecycle execution instruction unit that instructs the execution of the lifecycle when the execution condition of the lifecycle is satisfied; and a lifecycle execution result notification unit that notifies the lifecycle execution result to the sender of the registration request of the execution condition of the lifecycle.

### (Supplementary Note 2)

The network functions virtualization management and orchestration device according to Supplementary Note 1, wherein the pre-resource securing unit assigns management identification information to one or more resources secured in advance.

### (Supplementary Note 3)

The network functions virtualization management and orchestration apparatus according to Supplementary Note 1 or 2, further comprising a reserved resource reallocation unit that releases a predetermined resource among resources secured in advance for a first virtual function and allocates the released resource to a second virtual function.

### (Supplementary Note 4)

The network functions virtualization management and orchestration apparatus according to Supplementary Note 3, wherein the execution condition of the lifecycle includes
an information element for specifying a minimum necessary resource and a spare resource with respect to resources to be secured in advance for the virtual function,
wherein the reserved resource reallocation unit releases at least a part of the spare resource among resources secured in advance for the first virtual function and allocates the resource released to the second virtual function.

### (Supplementary Note 5)

The network functions virtualization management and orchestration apparatus according to Supplementary Note 3 or 4, wherein the execution condition of the lifecycle includes
an information element for setting a priority of the virtual function, wherein
the second virtual function is set to a higher priority than the first virtual function,
wherein the reserved resource reallocation unit releases at least a part of a spare resource secured in advance for the first virtual function with a low priority and allocates the resource released to the second virtual function with a higher priority.

### (Supplementary Note 6)

The network functions virtualization management and orchestration device according to any one of Supplementary Note 1 to 5, wherein the virtual function is a virtualized network function (VNF: Virtualized Network Function).

### (Supplementary Note 7)

The network functions virtualization management and orchestration apparatus according to Supplementary Note 6, wherein the sender is an element management system (EMS), wherein a VNF manager (VNFM) receives from the EMS a registration request of an execution condition of the VNF lifecycle to register the execution condition, and
the VNF manager (VNFM) sends a reservation grant request to an NFV orchestrator regarding the resources necessary for the execution of the VNF lifecycle, and wherein
the NFV orchestrator makes a virtualization infrastructure manager (VIM) pre-secure a resource of a network function virtualization infrastructure (NFVI).

### (Supplementary Note 8)

The network functions virtualization management and orchestration apparatus according to Supplementary Note 7, wherein the VNF manager (VNFM) instructs the virtualization infrastructure manager (VIM) to execute the VNF lifecycle when the execution condition of the lifecycle of the VNF is satisfied.

### (Supplementary Note 9)

A method for network functions virtualization management and orchestration comprising:
receiving, from a sender, a registration request of an execution condition of a lifecycle of a virtual function under a virtual environment to register the execution condition of the lifecycle in a storage unit;
securing in advance one or more resources necessary for execution of the lifecycle in the virtual function;
determining whether or not the execution condition of the lifecycle registered in the storage unit is satisfied;
instructing the execution of the lifecycle when the execution condition of the lifecycle is satisfied; and
notifying the lifecycle execution result to the sender of the registration request of the execution condition of the lifecycle.

### (Supplementary Note 10)

The method for network functions virtualization management and orchestration according to Supplementary Note 9, comprising assigning management identification information to one or more resources secured in advance.

(Supplementary Note 11)

The method for network functions virtualization management and orchestration according to Supplementary Note 9 or 10, comprising
releasing a predetermined resource among resources secured in advance for a first virtual function and allocating the released resource to a second virtual function.

### (Supplementary Note 12)

The method for network functions virtualization management and orchestration according to any one of Supplementary Notes 9 to 1, wherein the execution condition of the lifecycle includes
an information element for specifying a minimum necessary resource and a spare resource with respect to resources to be secured in advance for the virtual function, and
resource secured in advance by the pre-resource securing unit includes a minimum necessary resource and a spare resource,
the method comprising
releasing at least a part of the spare resource among resources secured in advance for the first virtual function and allocating the resource released to the second virtual function.

### (Supplementary Note 13)

The method for network functions virtualization management and orchestration according to any one of Supplementary Notes 9 to 12, wherein the execution condition of the lifecycle includes
an information element for setting a priority of the virtual function, wherein
the second virtual function is set to a higher priority than the first virtual function, the method comprising
releasing at least a part of the spare resource secured in advance for the first virtual function with a low priority and allocating the resource released to the second virtual function with a higher priority.

### (Supplementary Note 14)

The method for network functions virtualization management and orchestration according to any one of Supplementary Note 9 to 13, wherein the virtual function is a virtualized network function (VNF: Virtualized Network Function).

### (Supplementary Note 15)

The method for network functions virtualization management and orchestration according to Supplementary Note 14, wherein the sender is an element management system (EMS),
wherein a VNF manager (VNFM) receives from the EMS a registration request of an execution condition of the VNF lifecycle to register the execution condition, and
the VNF manager (VNFM) sends a reservation grant request to an NFV orchestrator regarding the resources necessary for the execution of the VNF lifecycle, and
wherein the NFV orchestrator makes a virtualization infrastructure manager (VIM) pre-secure a resource of a network function virtualization infrastructure (NFVI).

### (Supplementary Note 16)

The method for network functions virtualization management and orchestration according to Supplementary Note 15, wherein the VNF manager (VNFM) instructs the virtualization infrastructure manager (VIM) to execute the VNF lifecycle when the execution condition of the lifecycle of the VNF is satisfied.

### (Supplementary Note 17)

A non-transitory computer readable medium storing a program causing a computer to execute processing comprising:
receiving, from a sender, a registration request of an execution condition of a lifecycle of a virtual function under a virtual environment to register the execution condition of the lifecycle in a storage unit;
securing in advance one or more resources necessary for execution of the lifecycle in the virtual function;
determining whether or not the execution condition of the lifecycle registered in the storage unit is satisfied;
instructing the execution of the lifecycle when the execution condition of the lifecycle is satisfied; and
notifying the lifecycle execution result to the sender of the registration request of the execution condition of the lifecycle.

### (Supplementary Note 18)

The non-transitory computer readable medium according to Supplementary Note 17, storing the program causing the computer to execute processing comprising
releasing a predetermined resource among resources secured in advance for a first virtual function and allocating the released resource to a second virtual function.

### (Supplementary Note 19)

The non-transitory computer readable medium according to Supplementary Note 17 or 18, wherein the virtual function is a virtualized network function (VNF).

What is claimed is:

1. A network functions virtualization management and orchestration apparatus comprising
a processor configured to perform processing including:
upon receiving a registration request of an execution condition of a lifecycle of a virtual function under a virtual environment, securing in advance one or more resources necessary for execution of the lifecycle, and
when detecting that the execution condition of the lifecycle registered is satisfied, carrying out instructing execution of the lifecycle.

2. The network functions virtualization management and orchestration apparatus according to claim 1, comprising:
a lifecycle execution condition registration unit that receives, from a sender, the registration request of the execution condition of the lifecycle of a virtual function under a virtual environment and registers the execution condition of the lifecycle in a storage unit;
a pre-resource securing unit that secures in advance one or more resources necessary for execution of the lifecycle in the virtual function;
a lifecycle execution condition determination unit that determines whether or not the execution condition of the lifecycle registered in the storage unit is satisfied;
a lifecycle execution instruction unit that instructs the execution of the lifecycle when the execution condition of the lifecycle is satisfied; and
a lifecycle execution result notification unit that notifies the lifecycle execution result to the sender of the registration request of the execution condition of the lifecycle.

3. The network functions virtualization management and orchestration apparatus according to claim 1, wherein the pre-resource securing means unit assigns management identification information to one or more resources secured in advance.

4. The network functions virtualization management and orchestration apparatus according to claim 1, further comprising
a reserved resource reallocation unit that releases a predetermined resource among resources secured in advance for a first virtual function and allocates the released resource to a second virtual function.

5. The network functions virtualization management and orchestration apparatus according to claim 4, wherein the execution condition of the lifecycle includes
an information element for specifying a minimum necessary resource and a spare resource with respect to resources to be secured in advance for the virtual function,
wherein the reserved resource reallocation unit releases at least a part of the spare resource among resources secured in advance for the first virtual function and allocates the resource released to the second virtual function.

6. The network functions virtualization management and orchestration apparatus according to claim 4, wherein the execution condition of the lifecycle includes
an information element for setting a priority of the virtual function,
wherein the second virtual function is set to a higher priority than the first virtual function,
wherein the reserved resource reallocation unit releases at least a part of a spare resource reserved for the first virtual function with a low priority and allocates the resource released to the second virtual function with a higher priority.

7. The network functions virtualization management and orchestration apparatus according to claim 1, wherein the virtual function is a virtualized network function (VNF).

8. The network functions virtualization management and orchestration apparatus according to claim 7, wherein the sender is an element management system (EMS), wherein
a VNF manager (VNFM) receives, from the EMS, a registration request of an execution condition of the VNF lifecycle to register the execution condition, and
the VNF manager (VNFM) sends a reservation grant request to an NFV orchestrator regarding the resources necessary for the execution of the VNF lifecycle, and wherein
the NFV orchestrator makes a virtualization infrastructure manager (VIM) pre-secure resources of a network function virtualization infrastructure (NFVI).

9. The network functions virtualization management and orchestration apparatus according to claim 8, wherein the VNF manager (VNFM) instructs the virtualization infrastructure manager (VIM) to execute the VNF lifecycle when the execution condition of the lifecycle of the VNF is satisfied.

10. A method for network functions virtualization management and orchestration, comprising:
receiving, from a sender, a registration request of an execution condition of a lifecycle of a virtual function under a virtual environment to register the execution condition of the lifecycle in a storage unit;
securing in advance one or more resources necessary for execution of the lifecycle in the virtual function;
determining whether or not the execution condition of the lifecycle registered in the storage unit is satisfied;
instructing the execution of the lifecycle when the execution condition of the lifecycle is satisfied; and
notifying the lifecycle execution result to the sender of the registration request of the execution condition of the lifecycle.

11. A program A non-transitory computer readable medium storing a program causing a computer to execute processing comprising:
receiving, from a sender, a registration request of an execution condition of a lifecycle of a virtual function under a virtual environment to register the execution condition of the lifecycle in a storage unit;
securing in advance one or more resources necessary for execution of the lifecycle in the virtual function;
determining whether or not the execution condition of the lifecycle registered in the storage unit is satisfied;
instructing the execution of the lifecycle when the execution condition of the lifecycle is satisfied; and
notifying the lifecycle execution result to the sender of the registration request of the execution condition of the lifecycle.

12. (canceled)
